(19) United States
(12) Patent Application Publication
(10) Pub. No.: US 2010/0120593 A1
(43) Pub. Date: May 13, 2010

(54) Device for processing a flat material web, and method for processing a flat material web

(75) Inventors: Horst-Elmar Böhm, Herzogenaurach (DE); Stefan Müller, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, München (DE)

(21) Appl. No.: 12/523,764

(22) PCT Filed: Jan. 25, 2008
(86) PCT No.: PCT/EP2008/050858

§ 371 Date: Jan. 20, 2010

(30) Foreign Application Priority Data
Jan. 29, 2007 (DE) 10 2007 004 309.2

(51) Int. Cl. B26D 5/34; B26D 1/36

(52) U.S. Cl. 493/11; 83/331; 83/334; 83/649; 493/22

(57) ABSTRACT

A device for processing a flat material web including a sensor for detecting processing marks of the material web is provided. A control unit assigns a first location information to each detected processing mark. Furthermore, the control unit and a processing unit assign a second location information to the time of processing of the processing mark. Both pieces of location information are calculated together by the control unit to determine a correcting value. A processing position of the material web is corrected by the correcting value.

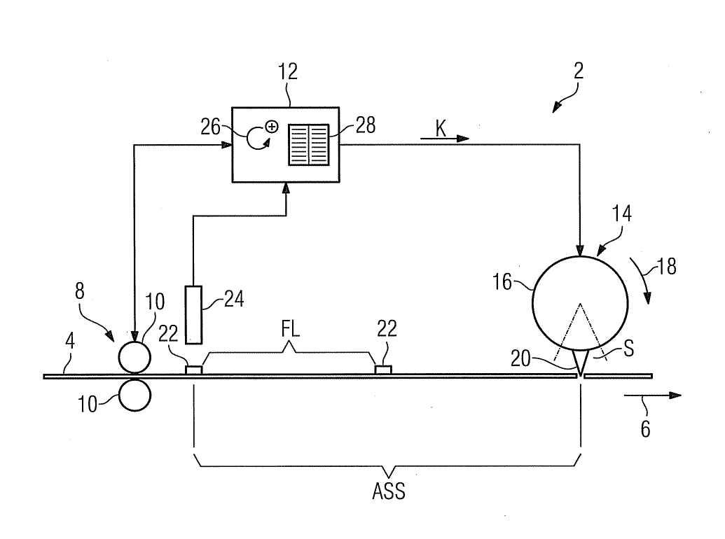

### CROSS REFERENCE TO RELATED APPLICATIONS

This application is the U.S. National Stage of International Application No. PCT/EP2008/050858 filed Jan. 25, 2008 and claims the benefit thereof. The International Application claims the benefits of German Patent Application No. 10 2007 004 309.2 DE filed Jan. 29, 2007; both of the applications are incorporated by reference herein in their entirety.

### FIELD OF INVENTION

The invention relates to a device for processing a flat material web and a method for processing a flat material web.

### BACKGROUND OF INVENTION

A device of this kind enables, for example, a paper roll to be divided into individual sheets, the paper roll being fed by means of a transport mechanism comprising a plurality of powered drive rollers to a cutting device and divided by same into equal sized sheets. Cardboard boxes are produced from a flat web of paperboard. Individual sheets are cut to size from the paperboard. Before the individual pre-cut sheets are separated from the web, perforations for subsequent folding of the sheet are made in same. Such a pre-cut sheet is described, for example, in DE 101 06 548 A1. In particular a cross cutter is used as the cutting device and for making the perforations.

Such a cross cutter and its mode of operation is described in the SIEMENS corporate publication, “Technologie-CPU 317T-2DP, Querschneider mit linearer Schnittkurve auf Basis von dynamisch berechneten Kurvenscheiben” (cross cutter with linear intersection curve based on dynamically calculated cam disks) dated Jul. 26, 2004. The blade of the cross cutter is disposed on a rotating cylinder whose axis does not move with the web. The rotation speed of the rotating cylinder is adjusted by means of a cam disk predefined by a control unit. This adjustment takes place such that during the cutting operation the rotation of the rotating cylinder is synchronized to the movement of the web. Between two cutting operations, the rotation speed is matched to the format length, the latter being the distance between two cuts.

If always the same cutting sequences are performed by means of the cutting device, it would in principle suffice to actuate the cutting device at predefined time intervals using a control device and execute a cut or a cutting sequence therewith. Particularly in the case of long webs, however, positioning inaccuracies may occur. One possibility is therefore to provide the web with spaced registration marks, these being in particular printed markings which are printed onto the web. These registration marks are detected by means of a sensor, in particular by means of an optical sensor. A correction is performed on the basis of these markings. If a cross cutter ensues as the processing unit, this is accomplished in particular by adjusting the cam disk.

It is also possible in the case of complicated cutting patterns with changing format lengths to automatically detect the distance between two registration marks, the so-called format distance, by means of sensor and continuously adjust the actuation of the cross cutter as a function thereof by means of a cam disk. Automatic adjustment to varying format lengths therefore takes place.

Lastly it is possible to combine automatic correction with automatic format length detection. In this case a sensor is used to detect the format distance and a second sensor to detect a possible positioning inaccuracy of the web, the first sensor being placed immediately downstream of a positive guide (drive rollers) for format length detection. Disposed at a distance from the first sensor in the transport direction, in particular near the cutting device, is arranged the second sensor for detecting positioning inaccuracies.

### SUMMARY OF INVENTION

An object of the invention is to specify a device for processing a web, providing both a simple means of correcting positioning inaccuracies and enabling format length to be automatically detected.

This object is achieved according to the invention by a device as claimed in the claims. For this purpose the device has a sensor for detecting registration marks. In the longitudinal direction following the sensor there is provided a cross cutter as processing unit for cyclically processing the web. There is additionally provided a control device with the aid of which two items of position information are acquired and offset one against the other to determine a correction value. With the first item of position information, the relevant registration mark is assigned a position value. For this purpose the registration mark is detected by a sensor as soon as it passes the sensor. At this detection instant, the current position value is detected as the first item of position information and stored. The second item of position information specifies a position value of the cross cutter or processing unit at the processing instant. The two items of position information are correlated with one another such that an absolute length measure in relation to the web can be determined from the difference between the two position values. To determine the correction value, an in particular fixed distance value (correction value non-zero) is additionally used which gives the distance between the sensor and the processing unit. If the difference between the two position values is at variance with the distance value, a correction is required. The amount of correction is proportional to the discrepancy. The correction is taken into account for a subsequent, in particular for the immediately following processing operation. Determination of the correction value is carried out in particular continuously, the correction value preferably being determined for each registration mark.

Of particular importance here is that an item of position information of the processing unit is determined at the processing instant, i.e. at the point in time when the web is being cut or perforated, for example. By means of this additional information, it can be determined in a purely computational manner whether, for example, cutting took place at precisely the desired location on the web or whether cutting took place too soon or too late and a correction is necessary. The use of the second item of position information obviates the need for a second sensor. With the device therefore, both automatic format length detection and automatic length correction are therefore advantageously carried out using a single sensor.

This exploits the fact that the transport mechanism and processing unit are controlled independently. The second item of position information of the processing unit in respect of the web is determined in particular at the web processing instant. In the case of a cross cutter as the processing unit, this is the making of a cut. This information is known to the control unit, as the latter actuates the cross cutter. The position information need merely be set against the first item of position information determined using the sensor. A second sensor for obtaining a correction value is therefore unnecessary, thereby saving the cost of such a sensor. The risk of failure of the measuring arrangement is therefore halved, as only one sensor is used instead of two sensors as before.

In addition, there is therefore also no processing of the position information measured with such a sensor. The control device can therefore be of simpler design. As the second item of position information is already present in the control device, the control device with its control logic can consequently also be of simpler and less expensive design. The error proneness of the device is reduced so that altogether a better cutting result is achieved. The risk of incorrect processing of the web which results in rejection and therefore increased production costs is therefore reduced.

The sensor is implemented, for example, as a proximity switch. Thus an optical proximity switch is suitable for detecting registration marks implemented as printed markers. A proximity switch of this kind is inexpensive and can be connected to the control unit in a simple manner.

If the web is transported very rapidly, the control unit is set up to also process measured values in the kHz range.

The control unit is set up to adjust the cam disk actuating the cross cutter by means of the correction value.

The control unit is advantageously designed to detect a numerical value correlated with the feedrate of the transport device. In addition, the control unit establishes as the first item of position information the numerical value at the registration mark detection instant and, as the second item of position information, the numerical value at the processing instant. As the control unit controls the transport device, the feedrate information is available in the control unit. An additional, further cost incurring measuring arrangement for the second item of position information is therefore unnecessary.

In an advantageous further development, there is provided, linked to the transport mechanism, an in particular incremental counter for supplying the numerical value. An incremental counter of this kind can be implemented simply and inexpensively. Moreover, it can be implemented in a high spatial resolution in the sub millimeter range, so that very accurate position information is provided.

The control unit is advantageously equipped to store the position information in an internal memory, thereby enabling a plurality of consecutively determined items of position information to be processed. This takes account of the fact that, between a registration mark just detected by the sensor and the processing unit, a plurality of further registration marks may be disposed on the web. Storing the items of position information makes successive control of the processing unit possible. In addition, in the event of a fault it is possible for particularly large deviations to be stored in this way in order to obtain further information about the state of the device.

The internal memory is, for example, a shift register. In this case only the current items of position information that are important for the instantaneous control of the transport mechanism and processing unit are held in memory for a short time. The control unit's memory therefore only needs to accommodate a small number of values and can therefore be implemented in a compact and consequently inexpensive manner.

In an advantageous further development, distance information is stored which represents the distance between the sensor and the processing unit and which is used to determine the correction value. This distance between the sensor and the processing unit is constant, as the sensor and the processing unit are fixed. This fixed distance corresponds to a fixed numerical value of the counter. This numerical value is added to the difference between the numerical values of the two items of position information in order to determine the correction value. The correction value is a measure of the positioning inaccuracy of the web.

In an advantageous variant, the processing unit is a cross cutter. By means of a cross cutter, particularly simple processing of the flat web can be performed. For determining a positioning inaccuracy of the web or also for detecting a change in format length, an adjustment of the cam disk controlling the cross cutter is calculated for subsequent processing operations. The cross cutter is controlled to compensate for the positioning inaccuracy or to adjust the format length using said adjusted cam disk. Because of the continuous determination of the correction value, it is ascertained, also for the new cam disk, whether the cutting position is correct. This is re-corrected if necessary. Correction value determination is carried out iteratively e.g. for each cutting operation.

The object is also achieved by a method for processing a flat web, wherein the web is transported in a longitudinal direction. Registration marks on the web are detected using a sensor. The web is processed by means of a processing unit disposed downstream of the sensor in the longitudinal direction. Each registration mark detected is assigned a first item of position information. In addition, a second item of position information of the processing unit is determined at the processing instant. The two items of position information are offset one against the other to determine a correction value. The features described with regard to the device for processing a web and their associated advantages likewise apply mutatis mutandis to the method.

### BRIEF DESCRIPTION OF THE DRAWINGS

An exemplary embodiment of the invention will now be explained with reference to the accompanying drawing.

FIGURE shows a schematic, greatly simplified representation of a device for processing a web.

### DETAILED DESCRIPTION OF INVENTION

The device 2 is used for transporting and processing a web 4. Webs 4 are defined in particular as continuous strips of material which are taken off a roll or which emerge directly from a continuous manufacturing or processing operation. Individual merchandise items such as sheets of paper, paperboard containers, packaging units, etc. are obtained from the web 4, in particular by cutting to length.

For moving the web 4 in the longitudinal direction 6 a transport mechanism 8 is provided. In the example, this comprises two drive rollers 10 implemented as positive guidance and positive drive for the web 4 and between which the web 4 is guided and driven. A control unit 12 is provided for controlling the entire device.

The web 4 is fed in the longitudinal direction 6 of the device 2 to a processing unit 14. In the example, this is implemented as a cross cutter which is actuated by the control unit 12. The cross cutter 14 has a cylinder 16 which rotates about its longitudinal axis in the direction indicated by the arrow 18. A rotating blade 20 entrained in the rotational direction 18 during rotation and fixed to the cylinder 16 cuts the web 4 at a defined position. The rotation rate of the cylinder 16 is predefined in a manner known per se by the control unit 12 by means of a cam disk not shown in greater detail here.

Disposed on the surface of the web 4 are spaced registration marks 22. The registration marks 22 are implemented as printed markings and, in particular, imprinted onto the surface of the web 4.

The device 2 is designed both for automatic format length detection and for automatic correction of the processing position, in particular the cutting position, with respect to the web 4. For this purpose the device only has one sensor 24 which is implemented in particular as an optical proximity switch.

Automatic format length detection is particularly advantageous if different merchandise items, in particular merchandise items of different length, are to be cut from the web 4. The particular format length is identified by the different distances between the registration marks 22 on the web 4.

To continuously ensure precise cutting of the web 4, monitoring of the processing or cutting position in respect of the web 4 is necessary, particularly in the case of elastic webs 4.

In the example, the transport mechanism 8 is linked to an incremental counter 26 which is incorporated in the control unit 12. The numerical value is therefore a measure of the feedrate of the web effected by the positive drive. The numerical value has, for example, a fixed, linear relationship to the number of revolutions of the drive rollers 10, the values of the incremental counter 26 increasing over time. For determining a position value, a so-called item of position information, an event is linked with the instantaneous numerical value of the incremental counter 26. This event is the detection instant of a printed marker by means of the sensor 24 or a processing instant, i.e. a cutting operation performed by the cross cutter 24. Said processing instant is known to the control unit 12 because of the actuation of the processing unit 14 or can at least be easily determined. The items of position information determined as numerical values are stored in an internal memory 28 of the control unit 12.

For format length detection, the printed markers 22 moving along with the web 4 in the longitudinal direction 6 are successively detected by means of the sensor 24 as position information posSₙ, posSₙ₋₁, where n is a continuous index. In this way a format length FLₙ is detected indirectly as the distance between two adjacent printed markers 22 and is stored in an internal memory 28, said format length FLₙ being calculated from the items of position information posSₙ, posSₙ₋₁ of the adjacent printed markers 22 by taking the difference:

FLₙ=posSₙ−posSₙ₋₁

As the items of position information posSₙ, posSₙ₋₁ represent values of the incremental counter 26, the format length FLₙ is likewise a numerical value. This format length FLₙ determined is used for the predefining by the control unit 12 of a cam disk matched to the format length FLₙ. For this purpose the control unit 12 applies a control signal K to the cross cutter 14, no adjustment of the rotation rate of the cylinder 16 to the feedrate of the web 4 taking place during immersion of the rotating blade 16 in the web 4. Instead, the cylinder 16 and the web 4 move at the same speed in a so-called synchronization range S in order to achieve a good cutting result. Outside the synchronization range S the rotation speed of the cylinder 16 is adjusted to the format length FLₙ by means of the cam disk K. The cam disk is re-calculated and adjusted for each format length FLₙ.

In addition, for each processing instant of the cross cutter 14 an item of position information posRKₙ is acquired which likewise corresponds to a numerical value of the incremental counter 26. This further item of position information posRKₙ is also stored in the internal memory 28. If the internal memory 28 is implemented, for example, as a kind of shift register, an unambiguous assignment of each item of position information posSₙ measured with the sensor 24 to the corresponding item of position information posRKₙ of the cross cutter 14 is achieved as a kind of truth table.

As a printed marker 22 moves from the sensor 24 to the cross cutter 14, the items of position information posRKₙ and therefore numerical values for the processing instant are always larger than the items of position information posSₙ and therefore numerical values of the sensor 24.

In addition, the sensor 24 and axis of rotation 16 of the cross cutter 14 are fixed and at a constant spacing which is calculated such that adjustment of the format length FLₙ can be reliably performed while the corresponding printed marker 22 corresponding to the format length FLₙ is moving to the cross cutter 14.

The distance between sensor 24 and cross cutter 14 can be converted into distance information ASS in particular as a numerical value of the incremental counter 26.

With the two items of position information posSₙ, posRKₙ and the distance information ASS, the correction value Δₙ can be easily calculated thus:

Δₙ=posSₙ+ASS−posRKₙ.

The correction value Δₙ is therefore likewise a numerical value, the sum posSₙ +ASS from the first item of position information posSₙ and the distance information ASS determining the numerical value that would have to be present at the instant of processing a printed marker 22. The numerical value for the position information posRKₙ at the processing instant is subtracted from this notional numerical value. The deviation represents the positioning inaccuracy of the web 4.

By means of the correction value Δₙ it can be determined whether a cutting operation took place too soon or too late at the desired location. If necessary, a correction of the cam disk K for the subsequent format length FLₙ detected by the sensor 24 can therefore be determined. In particular, an accumulation of positioning inaccuracies over time with continuous processing of the web 4 can be reliably avoided. The correction value Δₙ can therefore be determined in a simple manner using a single sensor 24.

1-12. (canceled)

13. A device for processing a flat web, comprising:
a power driven transport device for conveying the web in a longitudinal direction;
a sensor for detecting registration marks on the web;
a cross cutter arranged downstream of the sensor in the longitudinal direction for cyclically processing the web at a processing instant; and
a control unit configured
to assign a first position information in respect of the web to each detected registration mark,
to determine a second position information of the processing unit at the processing instant in respect of the web,
to offset the two position information one against the other to determine a correction value, and
to correct, if necessary, a processing position in respect of the web such that a cam disk controlling the cross cutter is adjusted by the correction value.

14. The device as claimed in claim 13, wherein the control unit is configured to detect a numerical value correlated with a feed rate of the transport device, and wherein the control unit establishes as the first position information a numerical value at the instant of detection of the registration mark by the sensor and, as the second position information, a numerical value at the processing instant.

15. The device as claimed in claim 14, further comprising:
an incremental counter linked to the transport device for supplying the numerical value.

16. The device as claimed in claim 13, wherein the control unit is configured to store the two position information in an internal memory.

17. The device as claimed in claim 14, wherein the control unit is configured to store the two position information in an internal memory.

18. The device as claimed in claim 16, wherein the internal memory is a shift register.

19. The device as claimed in claim 17, wherein the internal memory is a shift register.

20. The device as claimed in claim 13, wherein distance information is stored representing a distance between the sensor and the processing unit, and wherein the distance information is used to determine the correction value.

21. A method for processing a flat web, comprising:
transporting the flat web in a longitudinal direction;
detecting registration marks on the flat web by a sensor;
processing the flat web by a cross cutter, the cross cutter being arranged downstream of the sensor in the longitudinal direction;
assigning a first position information to each detected registration mark;
determining a second position information of the processing unit at the processing instant;
determining a correction value by offsetting the two position information one against the other; and
adjusting a cam disk actuating the cross cutter by the correction value.

22. The method as claimed in claim 21, wherein, for a subsequent processing of the flat web, automatic correction of the processing position in respect of the web is performed as a function of the correction value determined.

23. The method as claimed in claim 21, wherein an automatic format length detection of successive registration marks is performed based upon the first position information.

24. The method as claimed in claim 22, wherein an automatic format length detection of successive registration marks is performed based upon the first position information.

25. The method as claimed in claim 21, wherein numerical values correlated with a feed rate of the transport device are detected and a numerical value at an instant of detection of the registration mark by the sensor is established as the first position information and a numerical value at the processing instant is established as the second position information.

26. The method as claimed in claim 22, wherein numerical values correlated with a feed rate of the transport device are detected and a numerical value at an instant of detection of the registration mark by the sensor is established as the first position information and a numerical value at the processing instant is established as the second position information.

27. The method as claimed in claim 25, wherein the numerical values are supplied by an incremental counter linked to the transport device.

28. The method as claimed in claim 26, wherein the numerical values are supplied by an incremental counter linked to the transport device.

29. The method as claimed in claim 21, wherein the two position information are stored in an internal memory of the control unit.

30. The method as claimed in claim 29, wherein the internal memory is a shift register.

31. The method as claimed in claim 21, wherein distance information representing a distance between the sensor and the processing unit is stored, and wherein the distance information is used to determine the correction value by taking a difference between a differential difference between the two position information and the distance information.
